(19) United States
(12) Patent Application Publication
(10) Pub. No.: US 2025/0110455 A1
(43) Pub. Date: Apr. 3, 2025

(54) SYSTEMS AND METHODS FOR CONTROL BARRIER FUNCTIONS FOR ENHANCED FEASIBILITY IN OPTIMIZATION-BASED CONTROL

(71) Applicant: Toyota Motor Engineering & Manufacturing North America, Inc., Plano, TX (US)

(72) Inventors: Hardik PARWANA, Ann Arbor, MI (US); Mitchell Black, Plano, TX (US); Georgios Fainekos, Novi, MI (US); Bardh Hoxha, Canton, MI (US); Hideki Okamoto, Ann Arbor, MI (US); Danil V. Prokhorov, Canton, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/477,965

(22) Filed: Sep. 29, 2023

(51) Int. Cl. G05B 13/04

(52) U.S. Cl. CPC G05B 13/042

(57) ABSTRACT

A method, computer program product, and computer system for obtaining, by a computing device, a system state and dynamics model. User constraints in a controller for a control optimization may be obtained. A feasible space volume may be determined based upon, at least in part, the system state and dynamics model. A new control optimization may be determined based upon, at least in part, the feasible space volume. A control input for the controller may be executed based upon, at least in part, the new control optimization.

### BACKGROUND

Autonomous systems are generally equipped with controllers whose responsibility is to help the agent satisfy user given constraints under actuation limits that result from physical hardware. A common approach to designing such controllers is to pose them as optimization problems whose constraints are derived from given user constraints.

### SUMMARY

In one example implementation, a method, performed by one or more computing devices, may include but is not limited to obtaining, by a computing device, a system state and dynamics model. User constraints in a controller for a control optimization may be obtained. A feasible space volume may be determined based upon, at least in part, the system state and dynamics model. A new control optimization may be determined based upon, at least in part, the feasible space volume. A control input for the controller may be executed based upon, at least in part, the new control optimization.

One or more of the following example features may be included. The feasible space volume may be determined as an approximation for a current time. The feasible space volume may be determined as a future time. Determining the feasible space volume may include deriving a new constraint that restricts a rate of change of the feasible space volume. The user constraints may be augmented with the new constraint. Determining the feasible space volume may include deriving an update law for parameters in the user constraints such that the feasible space volume is one of increased or decreased within bounds. The parameters in the user constraints may be updated based upon, at least in part, the update law.

In another example implementation, a computing system may include one or more processors and one or more memories configured to perform operations that may include but are not limited to obtaining, by a computing device, a system state and dynamics model. User constraints in a controller for a control optimization may be obtained. A feasible space volume may be determined based upon, at least in part, the system state and dynamics model. A new control optimization may be determined based upon, at least in part, the feasible space volume. A control input for the controller may be executed based upon, at least in part, the new control optimization.

One or more of the following example features may be included. The feasible space volume may be determined as an approximation for a current time. The feasible space volume may be determined as a future time. Determining the feasible space volume may include deriving a new constraint that restricts a rate of change of the feasible space volume. The user constraints may be augmented with the new constraint. Determining the feasible space volume may include deriving an update law for parameters in the user constraints such that the feasible space volume is one of increased or decreased within bounds. The parameters in the user constraints may be updated based upon, at least in part, the update law.

In another example implementation, a computer program product may reside on a computer readable storage medium having a plurality of instructions stored thereon which, when executed across one or more processors, may cause at least a portion of the one or more processors to perform operations that may include but are not limited to obtaining, by a computing device, a system state and dynamics model. User constraints in a controller for a control optimization may be obtained. A feasible space volume may be determined based upon, at least in part, the system state and dynamics model. A new control optimization may be determined based upon, at least in part, the feasible space volume. A control input for the controller may be executed based upon, at least in part, the new control optimization.

One or more of the following example features may be included. The feasible space volume may be determined as an approximation for a current time. The feasible space volume may be determined as a future time. Determining the feasible space volume may include deriving a new constraint that restricts a rate of change of the feasible space volume. The user constraints may be augmented with the new constraint. Determining the feasible space volume may include deriving an update law for parameters in the user constraints such that the feasible space volume is one of increased or decreased within bounds. The parameters in the user constraints may be updated based upon, at least in part, the update law.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 are example flowcharts of an optimization process according to one or more example implementations of the disclosure;

FIG. 2 is an example flowchart of an optimization process according to one or more example implementations of the disclosure;

FIG. 3 is an example diagrammatic view of an example scenario of how feasible space changes;

FIGS. 4A-C are example diagrammatic views of an example scenario of a user's controller using two different hyperparameter gain values;

FIGS. 5A-D are example diagrammatic views of an example scenario of a user's controller using higher hyperparameter gain values than FIGS. 4A-C; and

FIGS. 6A-D are example diagrammatic views of an example scenario of an optimization process of a user's controller augmented with another constraint that puts restriction on a maximum rate of change of feasible volume according to one or more example implementations of the disclosure.

Like reference symbols in the various drawings may indicate like elements.

### DESCRIPTION

Autonomous systems are generally equipped with controllers whose responsibility is to help the agent satisfy user given constraints under actuation limits that result from physical hardware. A common approach to designing such controllers is to pose them as optimization problems whose constraints are derived from given user constraints. Since the constraints are usually dependent on the state of the system, for example, the position and velocity of a robot, the optimization problem changes as the agent changes its state (e.g., as the robot moves around). Ensuring that this optimization problem continues to admit a solution, i.e., it is feasible, as the autonomous agent keeps changing its state, is not trivial. The constraints of the optimization problem given by the user may generally be referred to as “user constraints” and the term “feasible space” may generally refer to the set of control input values that satisfies the user constraints. Additionally, optimization with user constraints only will be referred to as user optimization.

As will be discussed in greater detail below, the present disclosure may provide a way to prevent or delay infeasibility of the control optimization problem by either augmenting it with another constraint or by modifying parameters, if any, in the constraints. This modification may be based on the volume of feasible space of user constraints, its rate of change, or any quantity dependent on the volume and its gradient with respect to elements affecting the constraint. While the algorithmic framework holds for any optimization-based controller that is used to enforce any user-given constraints under actuation limits, the present disclosure is described as a non-limiting example for applications that enforce constraints using multiple control barrier function-based constraints (CBFs) in a quadratic program (QP) with actuation bounds. This class of controller may generally be referred to as CBF-QP controller without limitation to any specific controller.

Some solutions have imposed multiple control barrier functions in their controllers and proposed ways to ensure feasibility of the controller at all times. For instance, some solutions propose an offline sampling-and-grid refinement method to search the domain of state space over which multiple control barrier functions are compatible. Some solutions multiply a scalar penalty to the class-K functions in CBF-QP and create a dataset of persistently feasible and eventually infeasible parameters offline by randomly sampling parameters and simulating the system forward. Then they fit a differentiable classifier that is used to impose the resulting feasibility margin as another CBF constraint in the system. All of the aforementioned works, while explicitly focusing on feasibility, simply check if CBF-QP is feasible or not, which amounts to checking if feasible space volume is zero or non-zero. They do not consider the shape, size, and volume of feasible space or its rate of change in their design.

Among the online approaches, several works relax the CBF constraints to ensure that the optimization-based controller has a solution. For instance, some solutions propose an optimal-decay CBF-QP that multiplies the class-K function by a scalar variable that is optimized for (along with the control input) in the QP. Other solutions introduce similar relaxation strategies for CBF constraints with the subtle difference being that instead of linear multiplicative factor to generic class-K function, they only consider linear class-K functions and treat the class-K function parameter as an optimization variable. Still others impose control barrier function constraints for every state and input pair in a model predictive control (MPC) formulation, resulting in a nonlinear optimization problem. Other solutions may employ CBFs with penalty class-K functions to specify safety constraints at each time step of the MPC formulation to resolve the trade-off between feasibility and safety and enhance them both at the same time.

Multiple CBFs also arise naturally in multi-agent scenarios, where each work proposes a scheme to satisfy all CBF constraints simultaneously, but there exists no guarantees of the optimization-based controller to always have a solution in general for arbitrary dynamics models of robots, control input bounds and in presence of obstacles or other external environmental factors.

None of the aforementioned solutions utilize the feasible space volume (of QP or MPC) and its rate of change in their control or parameter adaptation design. The work most relevant to consideration and use of feasible space size and shape is for resolution of deadlock scenarios, where it considers double integrator modeled agents and the deadlock is defined as the velocity of a robotic agent becoming zero when the desired velocity is not zero. Under such a condition, if the feasible space of CBF-QP is not zero, it relaxes or tightens the barrier condition in the CBF-QP depending on whether the zero control input (zero acceleration in this case) lies on the one of the vertices or on one of the edges of the polytope that represents the feasible space. Note that the controller itself does not use feasible space shape or volume or rate of change of change of volume unless there is a deadlock. Even during a deadlock, it does not exploit polytope volume or its rate of change for resolution and is therefore different from the use of feasible space by optimization process 10.

Thus, the present disclosure represents an improvement over current technology in the sense that it monitors and then modifies the current technology to delay or prevent it from becoming infeasible by using the volume of feasible space, its gradient, or any other derived quantity. While the existing works also attempt to prevent infeasibility, they do not make use of the whole volume of the feasible space and its gradient in their design. The existing works either simply check if (1) CBF-QP is feasible or not, which amounts to checking if feasible space volume is zero or non-zero or (2) they use gradients of the solution of the optimization problem with respect to the states of robot and environment, however, they do not make use of the whole volume of the feasible space and its gradient. Monitoring the feasible space and its shape offers insight, more than existing works, to the closeness to and the pattern of failure of the optimization problem where failure refers to non-existence of a solution.

### The Optimization Process:

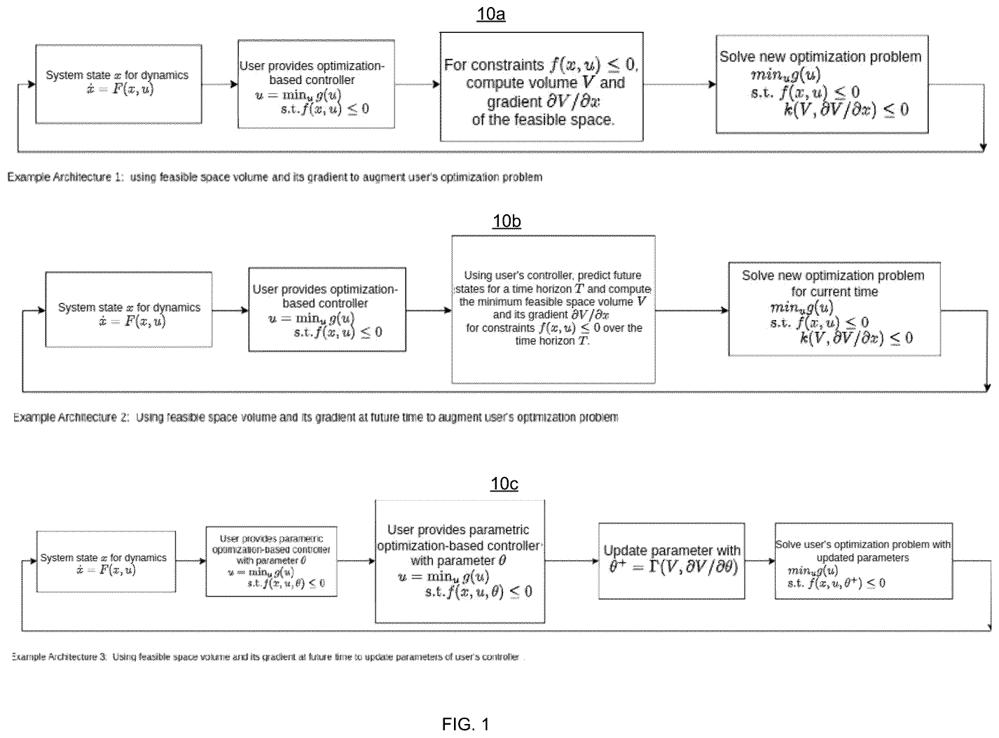

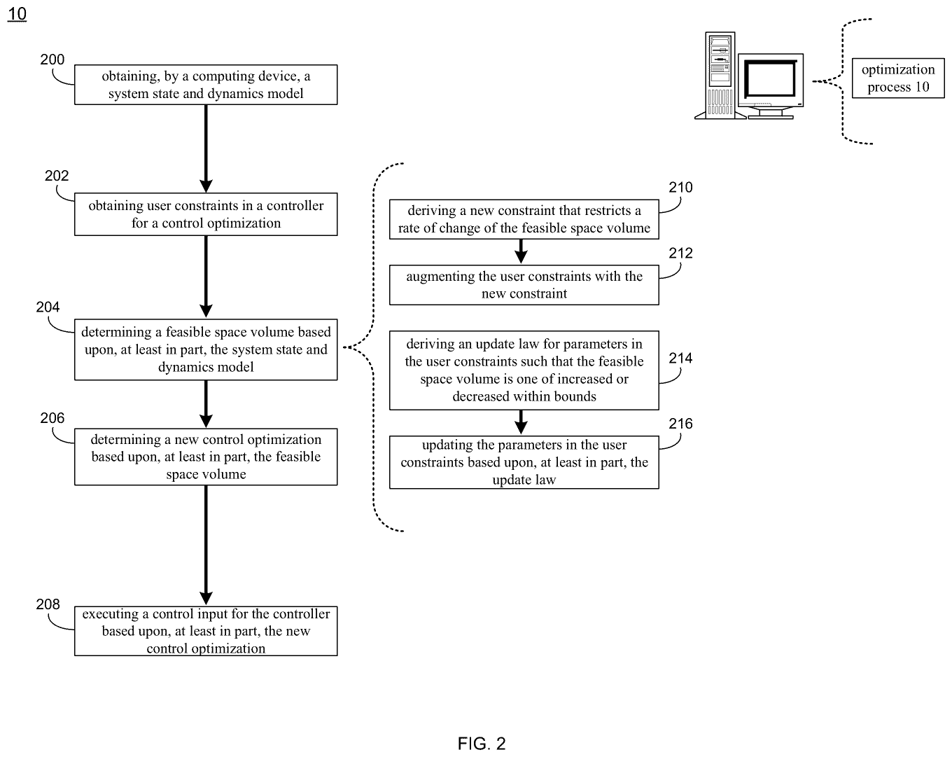

As discussed above and referring also at least to the example implementations of FIGS. 1-6, optimization process 10 may obtain 200, by a computing device, a system state and dynamics model. Optimization process 10 may obtain 202 user constraints in a controller for a control optimization. Optimization process 10 may determine 204 a feasible space volume based upon, at least in part, the system state and dynamics model. Optimization process 10 may determine 206 a new control optimization based upon, at least in part, the feasible space volume. Optimization process 10 may execute 208 a control input for the controller based upon, at least in part, the new control optimization.

FIG. 1 are example flowcharts of an optimization process (e.g., optimization process 10) according to one or more example implementations of the disclosure, where, in some implementations, optimization process 10 may obtain 200 a system state and dynamics model, obtain 202 user constraints in a controller for a control optimization, determine 204 a feasible space volume based upon, at least in part, the system state and dynamics model, and determine 206 a new control optimization based upon, at least in part, the feasible space volume. For instance, optimization process 10 may obtain the user constraints in the controller (an optimization problem) and determine the volume and gradient of its feasible space. There are multiple ways in which the feasible space may be used. For instance, FIG. 1 shows example and non-limiting closed-loop control architectures (10a-c) of optimization process 10 exploiting feasible space volume and its gradient for control design. For instance, as shown in 10a-10c of FIG. 1, X is the system state (e.g., a robot's position and heading angle), u is the control input (e.g., the robot's forward and rotation speed), F(x,u) is the dynamics function that governs the evolution of the system state. g(u) is the objective function of the optimization and f(x,u) are the user given constraints. K and Gamma are functions that depend on V and δV/δx or δV/δθ.

For instance, based on the volume and its gradient, the present disclosure may then augment user constraints with a new constraint that, for example, avoids faster than expected shrinkage of feasible space volume. Another use of feasible space is to use its volume to adapt the parameters present in user constraints. In the case of control barrier functions, the parameters may represent constants in class K functions. In some implementations, the feasible space volume may be determined as an approximation for a current time. For example, as shown in 10b of FIG. 1, the volume and its gradient may be determined for the feasible space of the controller at a current time. In some implementations, the feasible space volume may be determined as a future time. For example, as shown in 10c of FIG. 1, the original optimization-based may first be used to predict future states and the feasible space may be computed at some future states. In some implementations, determining the feasible space volume may include deriving 214 an update law for parameters in the user constraints such that the feasible space volume is one of increased or decreased within bounds, and updating 216 the parameters in the user constraints based upon, at least in part, the update law. For example, based on current parameters, optimization process 10 may use user optimization to compute control input and predict future states. Optimization process 10 may then compute feasible space volume at the future state and its gradient with respect to current parameters. Optimization process 10 may then use this gradient to update the parameters in direction of increasing feasible space volume. Thus, the flowcharts of 10a-c show possible closed-loop control architectures that illustrate the aforementioned applications.

In some implementations, the exact volume of the feasible space and its gradient may be difficult (or resource intensive) to determine. In these example scenarios, such as the ones disclosed, optimization process 10 may also use approximations of the volume of feasible space and its gradient, rather than (or in addition to) the exact volume of the feasible space and its gradient.

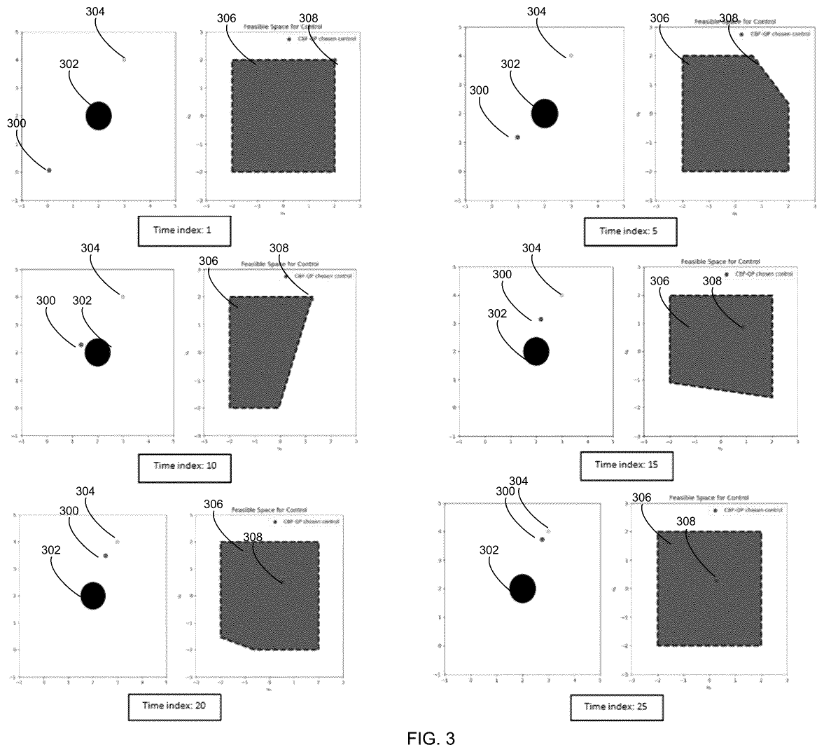

FIG. 3 is an example diagrammatic view of an example scenario of how feasible space changes for a CBF-QP controller as a holonomic robot navigates around an obstacle to reach its goal location without use of optimization process 10. In the example, the state of the holonomic robot is its position, and the control input is its velocity in horizontal and vertical directions. The maximum allowed speed in either direction is 2 units in this example. In addition to control input bounds (4 constraints), there is an additional CBF constraint that enforces collision avoidance with the circular obstacle resulting in a total of 5 constraints. The feasible space in this case is given by intersection of half spaces.

In each figure, the left subfigure shows the robot 300 navigating around a circular obstacle 302 to reach its goal location 304. The right subfigure shows the feasible space 306 and the control input 308 chosen by CBF-QP of optimization process 10. In the example, the maximum number of edges of the feasible space 306 at any given time is 5, as the number of constraints is 5. FIG. 3 shows that, from an application point of view, imposing the aforementioned bound also addresses a commonly observed issue the sensitivity to and the resulting degradation in performance of the controllers to their hyperparameters such as controller gains. The example shows a robot with dynamic unicycle model trying to reach its goal location while avoiding collision with static and dynamic obstacles using a CBF constraint designed by the user. The hyperparameter under consideration in this example is a gain parameter in the objective function of the CBF-QP. It is shown that when this hyperparameter is increased, the CBF-QP controller becomes infeasible at some point even though the constraints are the same. Augmenting the CBF-QP controller with an additional constraint (e.g., a new constraint that restricts the rate of change of the feasible space volume, an update law for the parameters in user constraints so that the feasible space volume is either increased or decreased within bounds, etc.) based on feasible space volume (e.g., at a current time or in a future time) prevents infeasibility and the robotic agent can successfully reach the goal. Note that the controller becoming infeasible does not necessarily imply that a collision happens. It only implies that the controller has failed. Controllers designed by users often are not necessary to maintain safety and only represent a sufficient condition whenever the system evolves in the controller's feasibility zone. In practice, it is desired though to operate in the controller's feasibility zone to avoid unexpected behavior and to exploit the theoretical guarantees that the controller offers.

Next, we show an application of optimization process 10, where the result serves at least two example purposes: (1) it shows that imposing a bound on the rate of change of the feasible space volume aids in preventing infeasibility of CBF-QP, and (2) that, from an application point of view, imposing the aforementioned bound also addresses a commonly observed issue the sensitivity to and the resulting degradation in performance of the controllers to their hyperparameters such as controller gains.

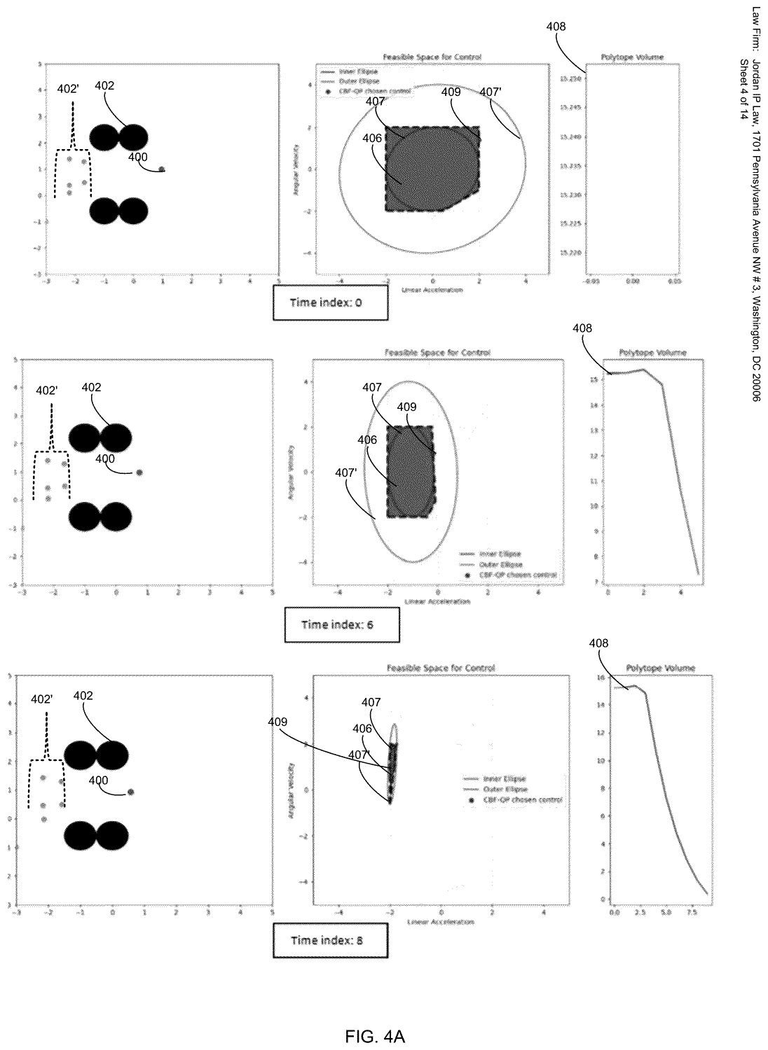

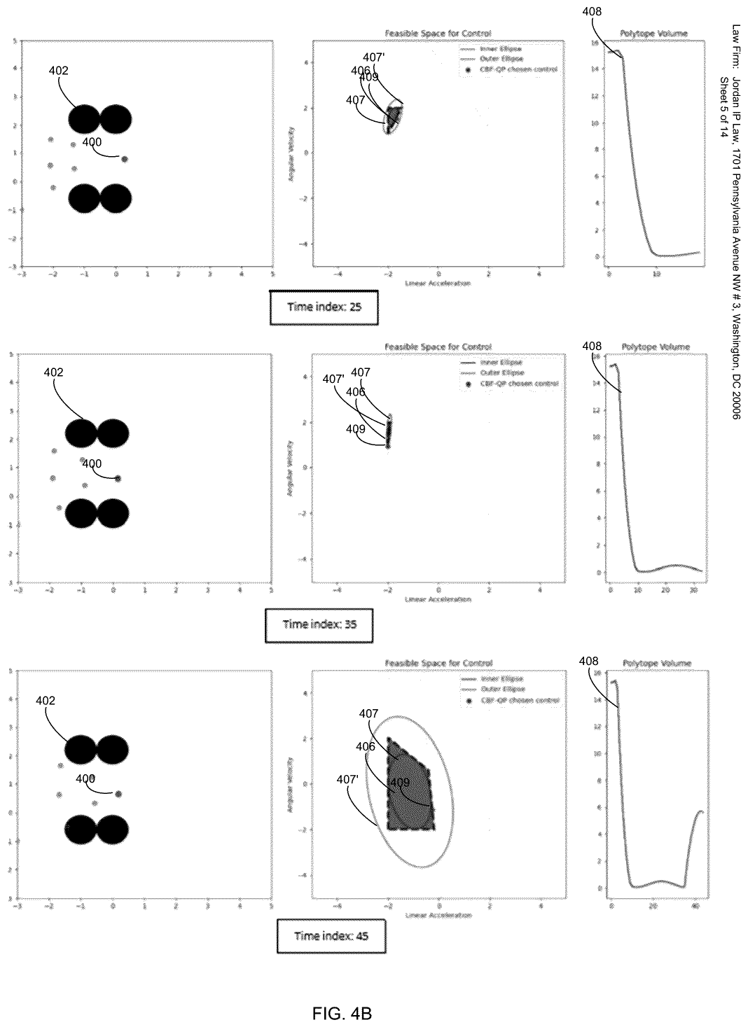

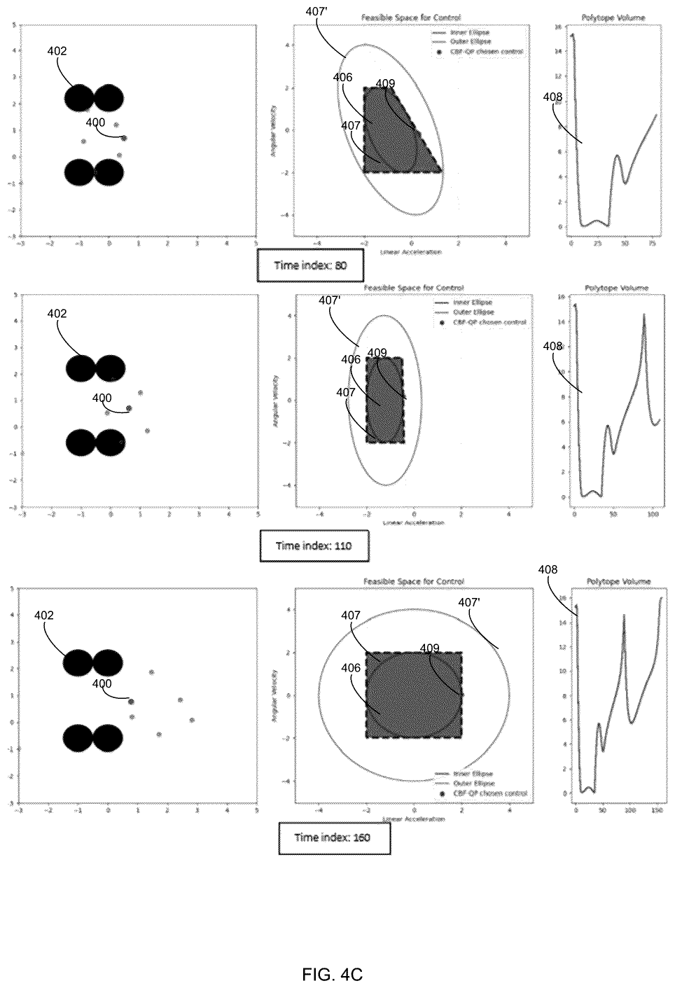

FIGS. 4A-C are example diagrammatic views of an example scenario of a user's controller using two different hyperparameter gain values. First, it can be seen the behavior of user's controller for two different hyperparameter gain values, with a visualization for a small gain value. As seen in FIGS. 4A-C, the user controller has a hyperparameter gain=1.0. In each figure, the left subfigure shows the robot 400 navigating around circular danger zones 402 and moving obstacles 402′ to reach its goal location. The middle subfigure shows the feasible space 406 and its inscribing ellipse 407 and outscribing 407′ ellipse that is used to approximate the feasible space volume. The control input 409 chosen by CBF-QP of optimization process 10. This approximation may be used for the control design. The right subfigure shows the volume of feasible space volume 408 variation with time. The controller is feasible for all time.

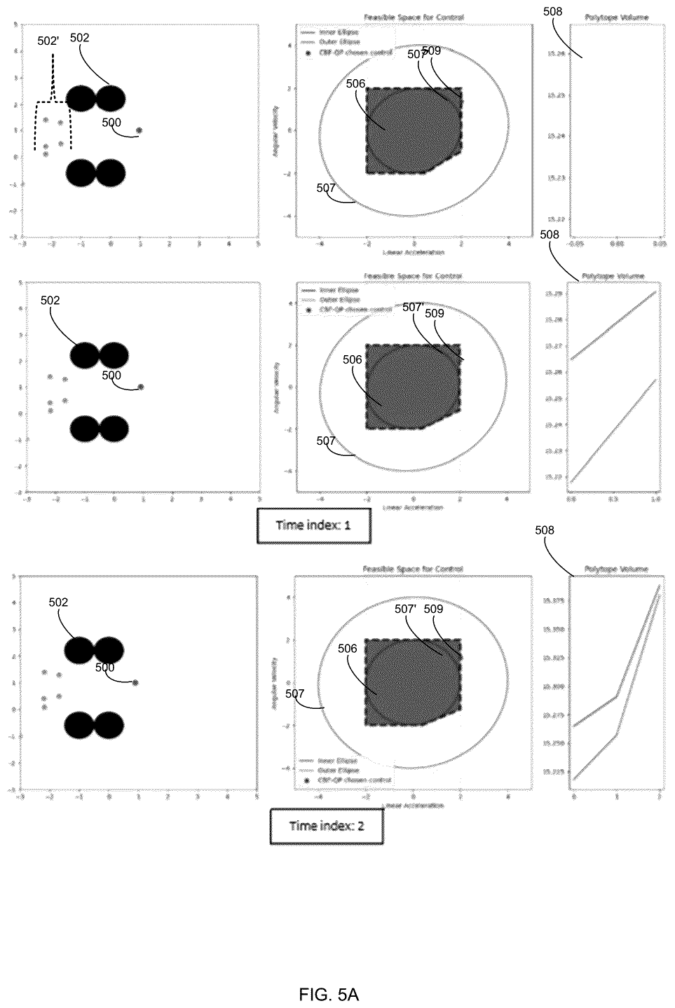

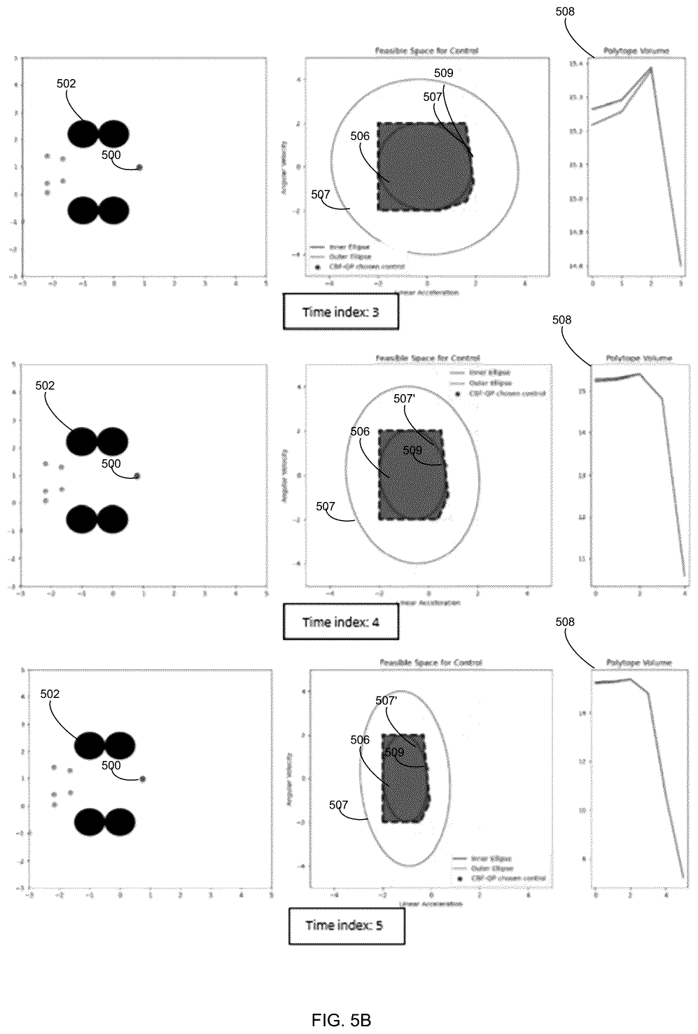

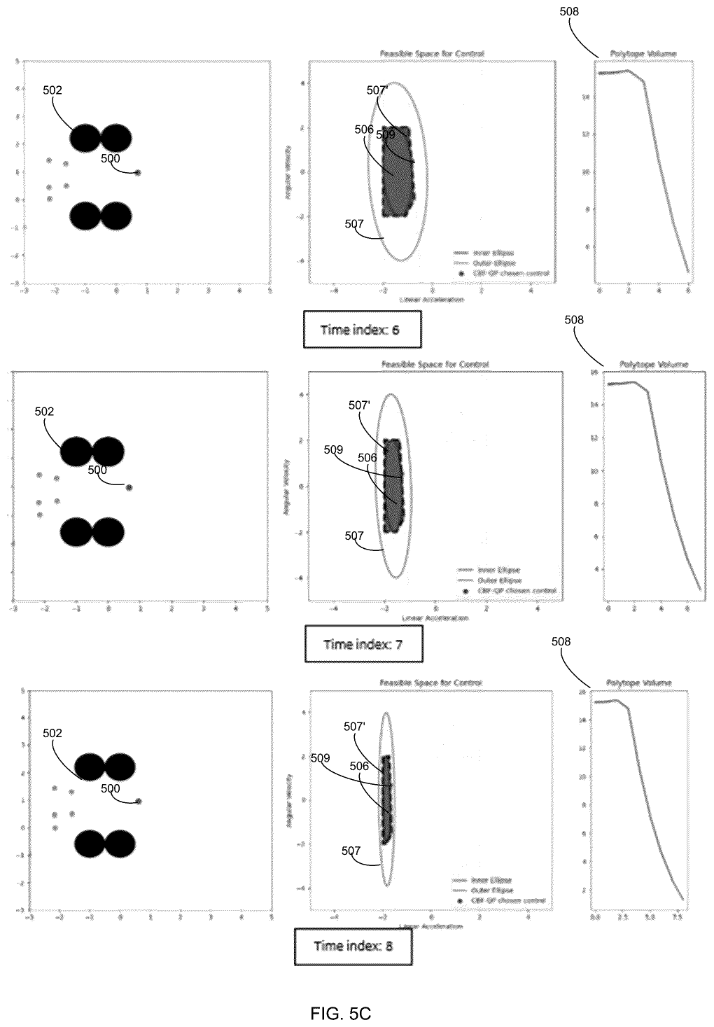

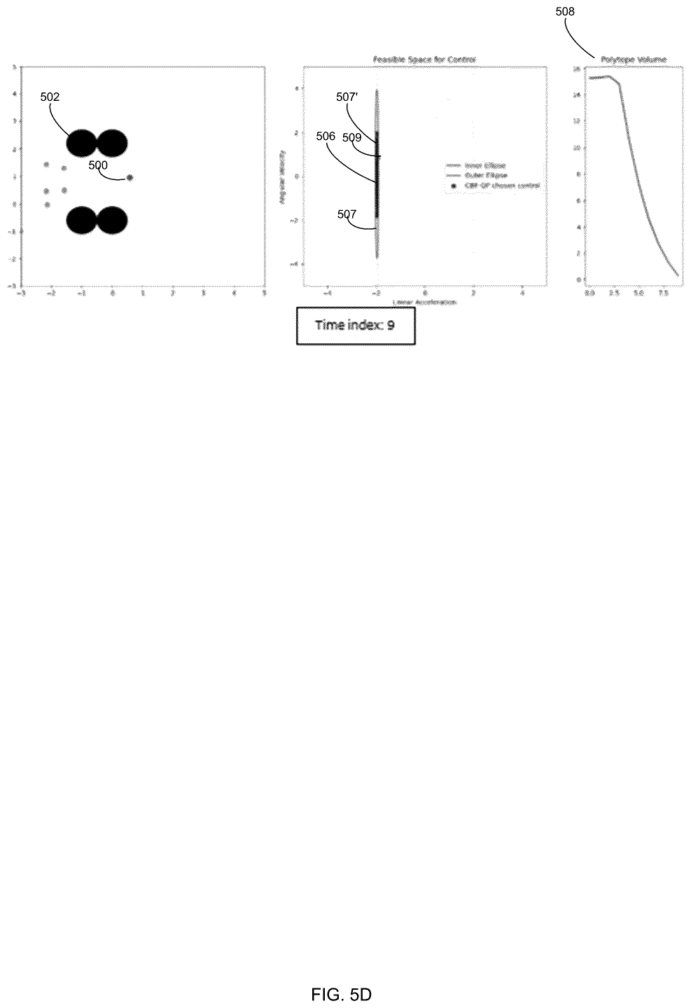

FIGS. 5A-D are example diagrammatic views of an example scenario of a user's controller using higher hyperparameter gain values than FIGS. 4A-C. The user controller has a hyperparameter gain=1.5. The feasible space goes to zero soon after simulation starts and the controller fails. In each figure, the left subfigure shows the robot 500 navigating around circular danger zones 502 and moving obstacles 502′ to reach its goal location. The middle subfigure shows the feasible space 506 and its inscribing ellipse 507 and outscribing 507′ ellipse that is used to approximate the feasible space volume. The control input 509 chosen by CBF-QP of optimization process 10. This approximation may be used for the control design. The right subfigure shows the volume of feasible space volume 508 variation with time. The controller is feasible for all times. As can be seen from FIGS. 5A-D, this results in the infeasibility of the controller.

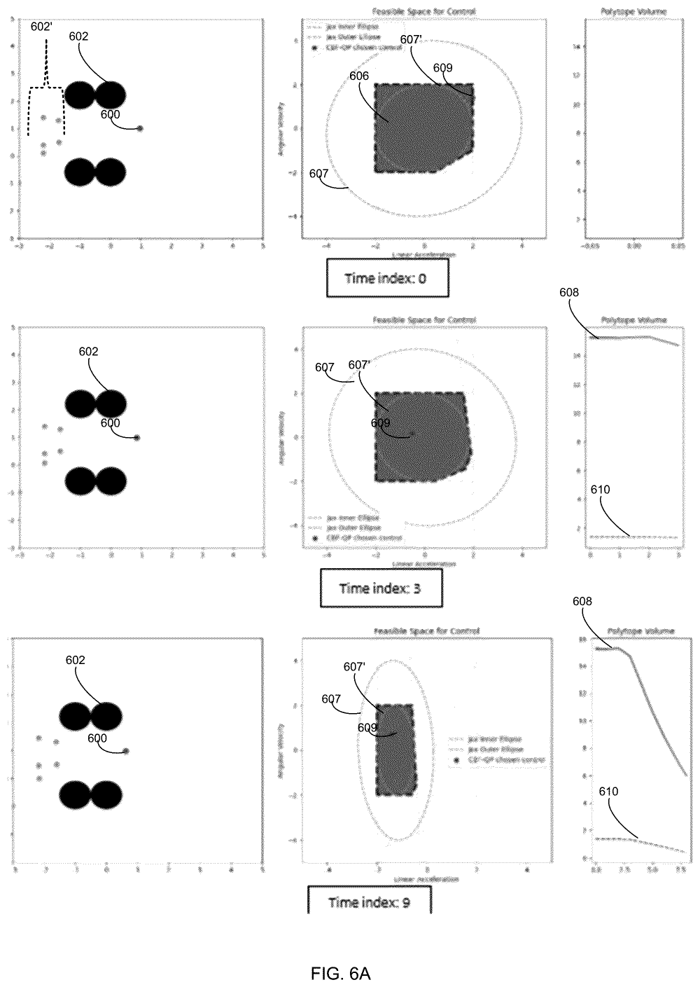

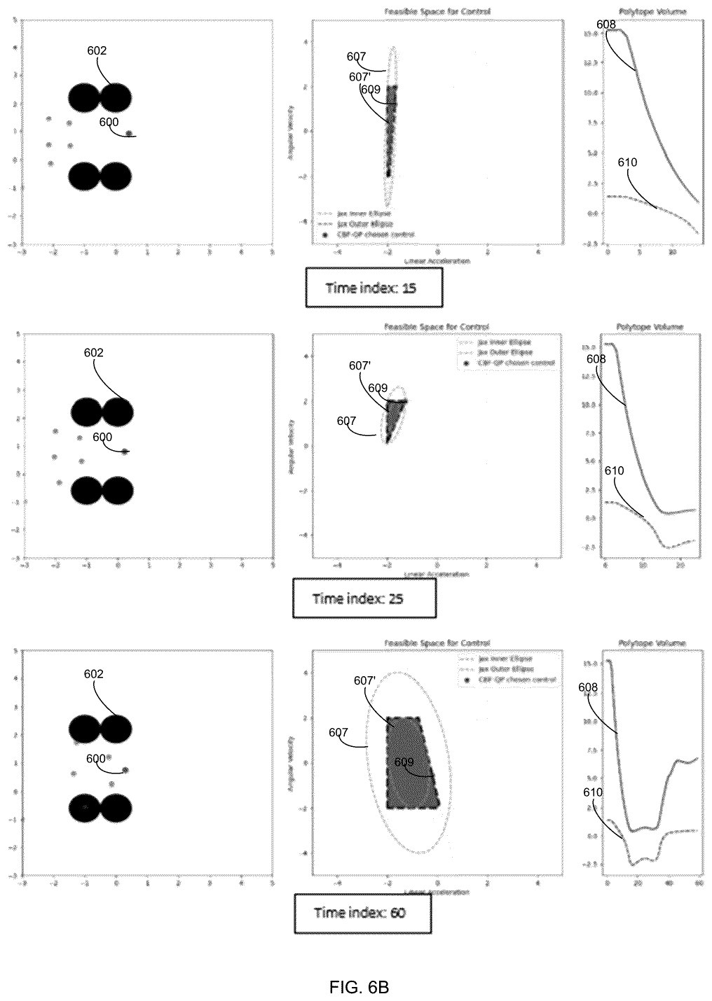

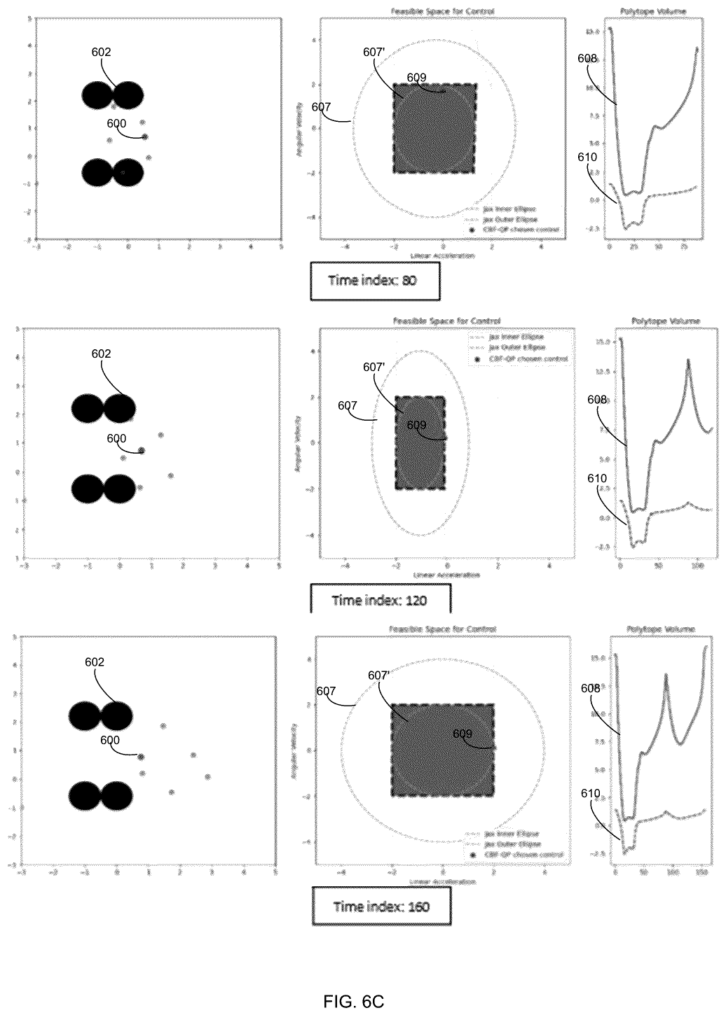

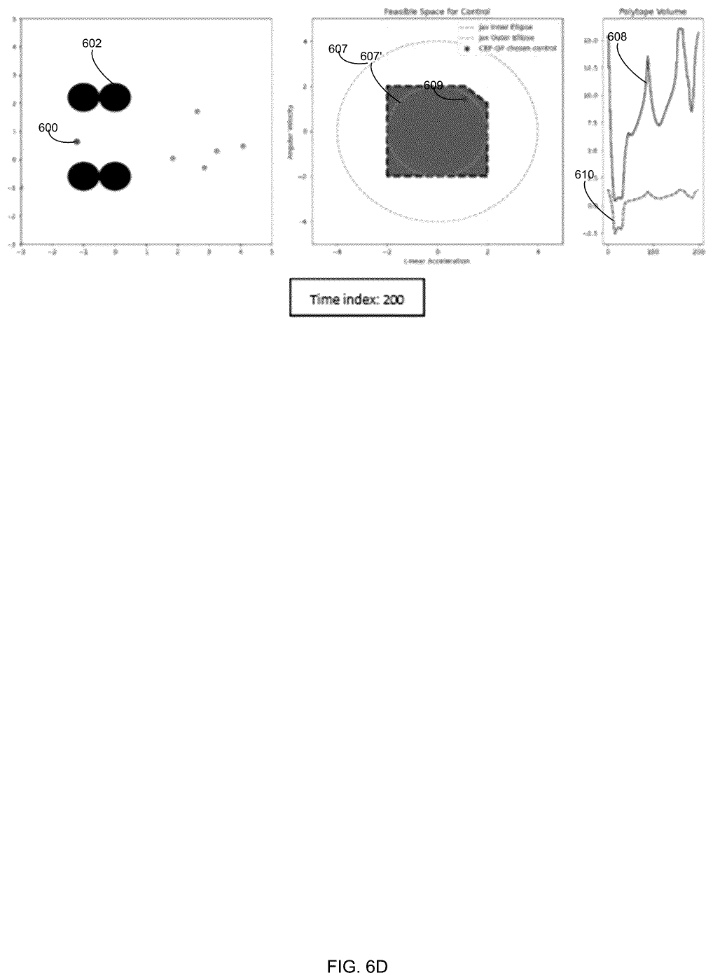

In some implementations, optimization process 10 may execute 208 a control input for the controller based upon, at least in part, the new control optimization. For example, FIGS. 6A-D are example diagrammatic views of an example scenario of an optimization process of a user's controller augmented with another constraint that puts restriction on a maximum rate of change of feasible volume according to one or more example implementations of the disclosure. In each figure, the left subfigure shows the robot 600 navigating around circular danger zones 602 and moving obstacles 602′ to reach its goal location. The middle subfigure shows the feasible space 606 and its inscribing ellipse 607 and outscribing 607′ ellipse that is used to approximate the feasible space volume. The control input 609 chosen by CBF-QP of optimization process 10 is then executed. This approximation may be used for the control design. The right subfigure shows the volume of feasible space volume 608 variation with time. The controller is feasible for all time. In some implementations, determining the feasible space volume may include deriving 210 a new constraint that restricts a rate of change of the feasible space volume and augmenting 212 the user constraints with the new constraint. For instance, with the user controller having hyperparameter gain=1.5 is also augmented with another constraint that puts restriction on the maximum rate of change of feasible volume, the feasible space does not go to zero and the robotic agent successfully reaches the goal location. The right subfigure in each figure shows the feasible space volume 608 variation with time. The solid line shows the actual volume. The dotted line 610 shows the inscribing ellipse's volume.

As will be appreciated by one skilled in the art after reading the present disclosure, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as JavaR, Smalltalk, C++ or the like. JavaR and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), etc. may execute the computer readable program instructions/code by utilizing state information of the computer readable program instructions to personalize the electronic circuitry, in order to perform aspects of the present disclosure. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc.

Examples of processing hardware may include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “coupled,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
obtaining, by a computing device, a system state and dynamics model;
obtaining user constraints in a controller for a control optimization;
determining a feasible space volume based upon, at least in part, the system state and dynamics model;
determining a new control optimization based upon, at least in part, the feasible space volume; and
executing a control input for the controller based upon, at least in part, the new control optimization.

2. The computer-implemented method of claim 1, wherein the feasible space volume is determined as an approximation for a current time.

3. The computer-implemented method of claim 1, wherein the feasible space volume is determined as a future time.

4. The computer-implemented method of claim 1, wherein determining the feasible space volume includes deriving a new constraint that restricts a rate of change of the feasible space volume.

5. The computer-implemented method of claim 4 further comprising augmenting the user constraints with the new constraint.

6. The computer-implemented method of claim 1, wherein determining the feasible space volume includes deriving an update law for parameters in the user constraints such that the feasible space volume is one of increased or decreased within bounds.

7. The computer-implemented method of claim 6 further comprising updating the parameters in the user constraints based upon, at least in part, the update law.

8. A computer program product residing on a computer readable storage medium having a plurality of instructions stored thereon which, when executed across one or more processors, causes at least a portion of the one or more processors to perform operations comprising:
obtaining, by a computing device, a system state and dynamics model;
obtaining user constraints in a controller for a control optimization;
determining a feasible space volume based upon, at least in part, the system state and dynamics model;
determining a new control optimization based upon, at least in part, the feasible space volume; and
executing a control input for the controller based upon, at least in part, the new control optimization.

9. The computer program product of claim 8, wherein the feasible space volume is determined as an approximation for a current time.

10. The computer program product of claim 8, wherein the feasible space volume is determined as a future time.

11. The computer program product of claim 8, wherein determining the feasible space volume includes deriving a new constraint that restricts a rate of change of the feasible space volume.

12. The computer program product of claim 11 wherein the instructions further comprise augmenting the user constraints with the new constraint.

13. The computer program product of claim 8, wherein determining the feasible space volume includes deriving an update law for parameters in the user constraints such that the feasible space volume is one of increased or decreased within bounds.

14. The computer program product of claim 13 wherein the instructions further comprise updating the parameters in the user constraints based upon, at least in part, the update law.

15. A computing system including one or more processors and one or more memories configured to perform operations comprising:
obtaining, by a computing device, a system state and dynamics model;
obtaining user constraints in a controller for a control optimization;
determining a feasible space volume based upon, at least in part, the system state and dynamics model;
determining a new control optimization based upon, at least in part, the feasible space volume; and
executing a control input for the controller based upon, at least in part, the new control optimization.

16. The computing system of claim 15, wherein the feasible space volume is determined as an approximation for a current time.

17. The computing system of claim 15, wherein the feasible space volume is determined as a future time.

18. The computing system of claim 15, wherein determining the feasible space volume includes:
deriving a new constraint that restricts a rate of change of the feasible space volume; and
augmenting the user constraints with the new constraint.

19. The computing system of claim 15, wherein determining the feasible space volume includes deriving an update law for parameters in the user constraints such that the feasible space volume is one of increased or decreased within bounds.

20. The computing system of claim 19 wherein the instructions further comprise updating the parameters in the user constraints based upon, at least in part, the update law.
